(19) United States
(12) Patent Application Publication
(10) Pub. No.: US 2024/0386939 A1
(43) Pub. Date: Nov. 21, 2024

(54) MEMORY ACCESS ANALYSIS

(71) Applicant: Arm Limited, Cambridge (GB)

(72) Inventor: Lorenzo Di Gregorio, Grasbrunn (DE)

(73) Assignee: Arm Limited, Cambridge (GB)

(21) Appl. No.: 18/692,395

(22) PCT Filed: Aug. 9, 2022
(86) PCT No.: PCT/GB2022/052067

§ 371 Date: Mar. 15, 2024

(30) Foreign Application Priority Data
Sep. 22, 2021 (GB) 2113479.6

(51) Int. Cl. G11C 11/4078; G11C 11/4076; G11C 11/408

(52) U.S. Cl. CPC G11C 11/4078; G11C 11/4076; G11C 11/408

(57) ABSTRACT

There is provided a data processing apparatus comprising: memory access circuitry configured to issue access requests to a memory system: estimation circuitry configured to estimate a statistical cardinality count on memory row addresses accessed by the access requests: and decay circuitry configured to apply an exponential time-based decay during estimation of the statistical cardinality count.

The present technique relates to data processing and particular memory access systems.

In a rowhammer attack, an attacker repeatedly accesses (or hammers) a given memory row of cells of a physical memory unit in an attempt to cause the stored bit of a memory cell in a neighbouring row to flip. If the flipped bit is sensitive, this can lead to privilege escalation, which is undesirable. It is desirable for such memory access patterns to be detectable so that evasive action can be taken. However, it may be possible to disguise such an access pattern, meaning that any evasion actions might not occur.

Viewed from a first example configuration, there is provided a data processing apparatus comprising: memory access circuitry configured to issue access requests to a memory system; estimation circuitry configured to estimate a statistical cardinality count on memory row addresses accessed by the access requests; and decay circuitry configured to apply an exponential time-based decay during estimation of the statistical cardinality count.

Viewed from a second example configuration, there is provided a data processing method comprising: issuing access requests to a memory system; estimating a statistical cardinality count on memory row addresses accessed by the access requests; and applying an exponential time-based decay during estimation of the statistical cardinality count.

Viewed from a third example configuration, there is provided a computer-readable medium to store computer-readable code for fabrication of a data processing apparatus comprising: memory access circuitry configured to issue access requests to a memory system; estimation circuitry configured to estimate a statistical cardinality count on memory row addresses accessed by the access requests; and decay circuitry configured to apply an exponential time-based decay during estimation of the statistical cardinality count.

The present technique will be described further, by way of example only, with reference to embodiments thereof as illustrated in the accompanying drawings, in which:

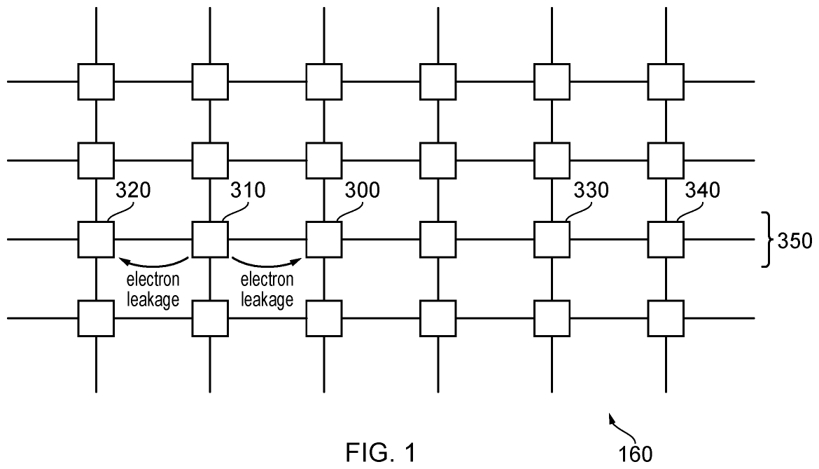

FIG. 1 illustrates an example of a memory system that is implemented using a number of trench capacitors;

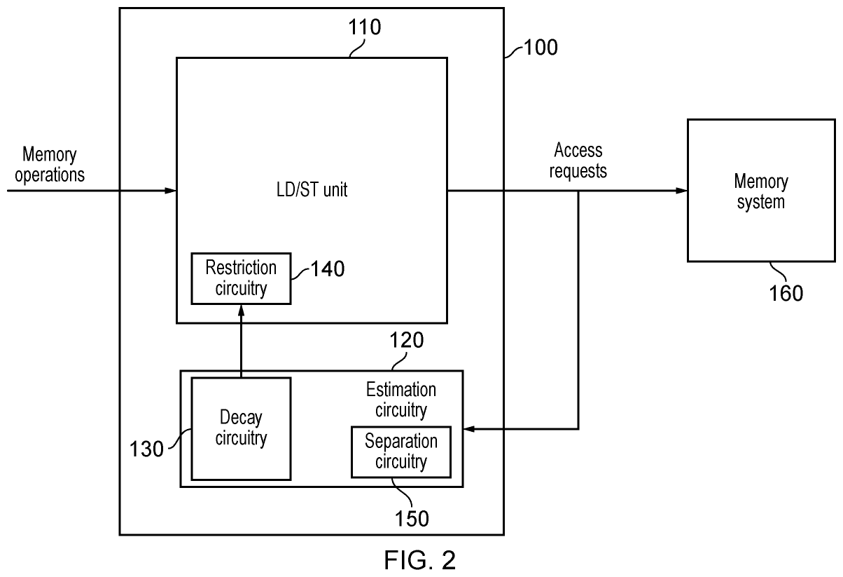

FIG. 2 schematically illustrates a data processing apparatus;

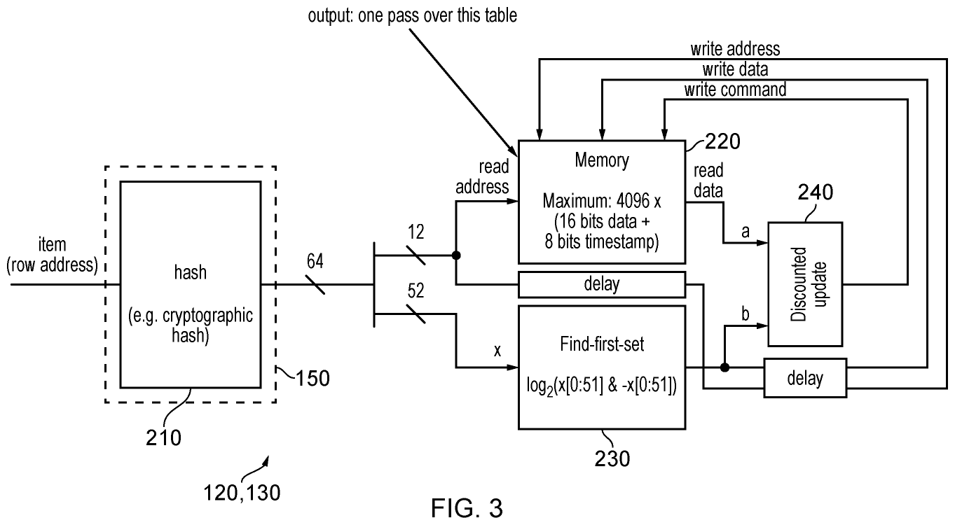

FIG. 3 illustrates an example of the estimation circuitry and decay circuitry;

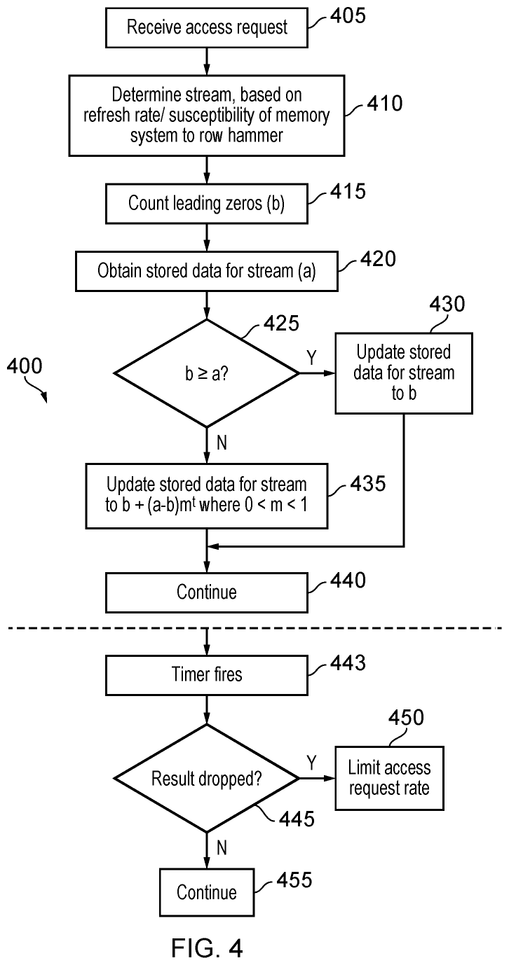

FIG. 4 illustrates a flowchart that shows a method of data processing; and

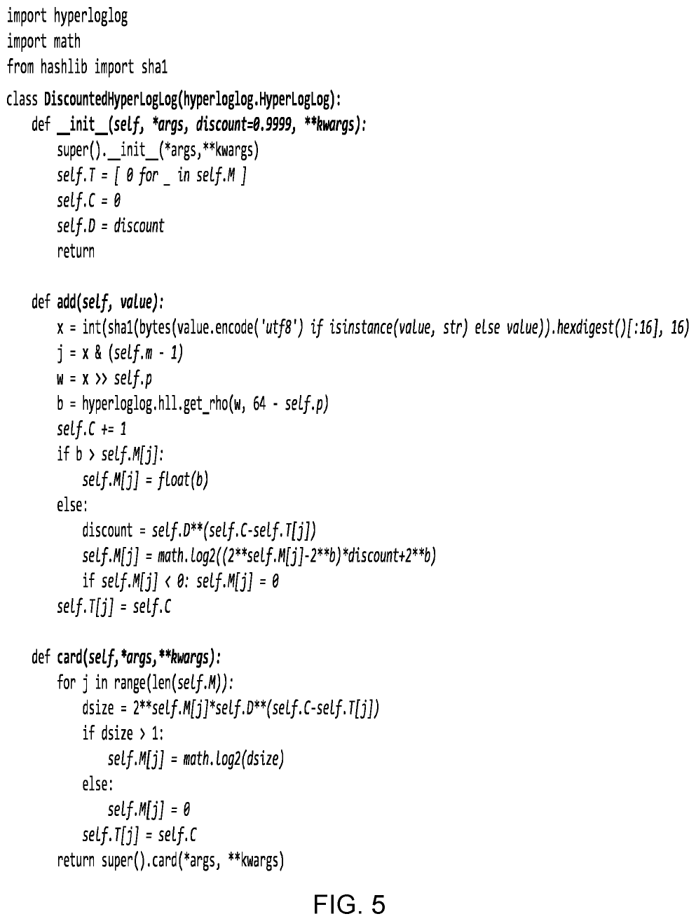

FIG. 5 illustrates source code (written in python) of an algorithm that implements the process illustrated by the flowchart of FIG. 4.

Before discussing the embodiments with reference to the accompanying figures, the following description of embodiments and associated advantages is provided.

In accordance with one example configuration there is provided a data processing apparatus comprising: memory access circuitry configured to issue access requests to a memory system; estimation circuitry configured to estimate a statistical cardinality count on the memory row addresses accessed by the access requests; and decay circuitry configured to apply an exponential time-based decay during estimation of the statistical cardinality count.

Rowhammer attacks can be theoretically detected by considering the number of accesses to unique rows (i.e. memory row addresses) that are made over a period. If, within that period, a large number of accesses are made to a same memory row as compared to other rows then it may be concluded that a rowhammer attack is being performed. In practice, however, counting the number of accesses to each unique row address is prohibitively expensive in terms of memory requirements. Such a system would seem to necessitate storage of a number of bits of information in digital or analog form for each individual memory row of cells, which is to say that for every row that can be stored in the system, several further bits would be needed to calculate the number of accesses to that row. Such an approach is therefore impractical at best. An alternative approach is to estimate the cardinality without actually recording each access request individually. However, merely knowing the cardinality is not sufficient because this overlooks the time component-rowhammer attacks rely on frequent accesses to a particular memory row in a short space of time (e.g. less than the refresh period of the underlying memory). It might be tempting to solve this problem by using a sliding window (e.g. by considering only access requests made in the last x milliseconds). However, such a technique can be ineffective in practice because rowhammer depends on the frequency of accesses, which might vary within a given sliding window and not be well identified. In addition, if the window slides then it becomes necessary to track when several individual access had occurred, which therefore significantly increases the storage and processing requirements. The present technique overcomes these limitations by applying an exponential time-based discount or decay. That is to say that the estimated statistical cardinality is adjusted according to how spaced apart certain accesses are. If the accesses are spaced far apart, then their statistical cardinality estimate is weighted less highly than if the accesses are spaced close together. As a consequence, rowhammer attacks can be better measured than would be possible with a sliding window and the storage requirements for detecting such attacks can also be reduced.

In some examples, the data processing apparatus comprises restriction circuitry configured to restrict the access requests in response to the statistical cardinality count. Based on the statistical cardinality count that has been estimated, a restriction can be placed on the pattern of access requests in order to reduce the frequency of the row accesses to be lower than a critical one for a rowhammer attack. Consequently, based on the access pattern indicating that a rowhammer attack could be taking place, the effectiveness of such an attack can be reduced.

In some examples, the restriction circuitry is configured to restrict the rate at which the access requests are issued to the memory system to at least some of the memory row addresses in response to the statistical cardinality count. As a consequence of this, few accesses are made in a short space of time and the probability of a bit flip occurring is reduced.

In some examples, the restriction circuitry is configured to restrict the access requests in response to the statistical cardinality count dropping. The drop in the statistical cardinality count could be a drop to a predefined value, or a drop by a certain amount (either a drop by a specific amount or a drop by a percentage amount). A drop in the statistical cardinality count estimate indicates a reduction in the number of unique row addresses being accessed, and this can therefore signify a rowhammer attack occurring because a high data throughput over few memory rows implies a high frequency access to at the least some of these rows.

In some examples, the estimation circuitry is configured to estimate the statistical cardinality count on the memory row addresses using a longest seen pattern in the memory row addresses. The pattern could be a contiguous number of most-significant zeros on the addresses. For example, if a first access request is to a row address 1000 (e.g. address 8) and a second access request is to a row address 1100 (e.g. address 12) then the maximum number of contiguous most-significant zeros (i.e. suffixed zeros in big endian representation) that have been seen is three. We could therefore assume, for a long stream of accesses, that the maximum number of contiguous most-significant zeros that have been seen is exactly enough to store all of the row addresses and that therefore the maximum number of distinct possible addresses is 2³=8. This estimate is a rough approximation, so can have a high variance (although this can be decreased by techniques described below). In these examples, a default starting value for the number of contiguous most-significant zeros seen can be zero. In some embodiments (as explained below) the row addresses might be hashed prior to the number of contiguous most-significant leading zeros being counted.

In some examples, the data processing apparatus comprises separation circuitry to separate the access requests into a plurality of substreams and to estimate the statistical cardinality count on the memory row addresses by estimating a statistical cardinality count for each of the substreams. By separating the access requests into a plurality of substreams, it is possible to estimate the statistical cardinality count by considering a number of ‘sample bins’, estimating the statistical cardinality count for each stream (or bin) and then combining these values in order to determine an overall statistical cardinality count.

There are a number of ways of taking the statistical cardinality count on the memory row addresses by using the statistical cardinality count for each of the substreams, but in some examples this is achieved by performing a centre-biasing function on the statistical cardinality count for each of the substreams. The centre-biasing function could be a normalising or averaging function such as a harmonic mean. For instance, if the statistical cardinality count of each of four substreams are calculated as A, B, C, D then the overall statistical cardinality count on the memory addresses can be calculated as ((A⁻¹+B⁻¹+C⁻¹+D⁻¹)/4)⁻¹. The harmonic mean can be thought of as a pessimistic mean in that it tends towards the smaller values of the set of values. Large outlying values are therefore given less weight.

In some examples, the data processing apparatus comprises hash circuitry to hash each of the memory row addresses prior to being provided to the estimation circuitry. The estimation circuitry therefore performs its estimation on at least part of the hashed row addresses rather than that (raw) original addresses. By using a hashing algorithm, the same input row address will provide the same output row address and thereby enable repeated accesses to the same memory row address to be identified. However, the relationship between groups of row addresses is otherwise ‘randomised’ so that nearby input row addresses produce distributed output row addresses. This makes it possible to better identify the estimated statistical cardinality count from legitimate row accesses that might otherwise be statistically too correlated. For instance, if a program iterates over an array of integers then a large number of memory row addresses will be highly localised. This could interfere with the estimated statistical cardinality count that operates using leading zeros because highly localised row addresses could be more likely to have a similar number of leading zeros. If, however, the input addresses are hashed then the resulting hashes will have a much spreader distribution. Consequently, the estimated statistical cardinality count is more likely to resemble the true cardinality count.

There are also a number of ways of separating the access requests into the substreams. However, in some examples, the accesses requests are separated into the plurality of substreams based on predetermined bits of the memory row addresses after being hashed. The use of a hash algorithm in this way might be expected to equally distribute row accesses between the substreams (e.g. bins). The access requests might be considered to be suspicious if some substreams have a zero statistical cardinality since this would indicate that only a small number of rows are being accessed.

In some examples, the hashes are cryptographic hashes. In this way, a relatively even distribution of the access requests (to the rows) should occur between the substreams. In some cases, the hash algorithm used to produce the hashes produces an avalanche effect (butterfly effect) and in some cases, the hash algorithm meets the strict avalanche criterion. An avalanche effect means that the changing of even a small part of the input to the hash function (e.g. a single bit) produces numerous differences in the resulting hash. Again, this can be used to provide a good distribution of addresses across the substreams.

In some examples, the estimation circuitry is configured to estimate, for each substream in the substreams, the statistical cardinality count of that substream by using a longest seen pattern in the memory row addresses of that substream. For instance, the pattern may be a maximum number of contiguous most-significant zeros in the memory row addresses belonging to that substream. The longest seen pattern in the substream can be used to provide a reasonable estimate with high variance of the number of unique row addresses accessed in that substream. By calculating such a value for each ‘random’ substream, it is possible to take a number of random samples of the longest seen unique patterns of the row memory accesses and use this to determine whether there is a particular bias. For instance, if the longest seen unique pattern for a particular substream is zero (which is the default starting value) then no accesses have been seen in that substream. This might simply be coincidence, but if several substreams have a zero estimated statistical cardinality then this suggests that a lot of accesses are being made to a small number of addresses (thereby causing no accesses to be seen for certain substreams), which is indicative of a rowhammer attack.

In some examples, the estimation circuitry comprises storage circuitry to store, in association with each substream of the substreams, a time at which a next-most recent one of the access requests associated with that substream was seen; and the decay circuitry is configured to adjust the statistical cardinality count for each substream of the row memory address substreams based on the time between successive ones of the access requests belonging to that substream. In this way, if a long time passes between accesses belonging to the same substream, then the statistical cardinality count is reduced. This is because an access that occurred a long time ago in a particular substream is of little interest and will not be part of a high frequency hammering. Such accesses should not be given significant consideration in determining whether a rowhammer attack is occurring.

In some examples, the exponential time-based decay is equal to a constant raised to the power of a time component; and the time component is based on the time between successive ones of the access requests belonging to that substream. Therefore, as the time between successive accesses of the substream increases, the difference increases and the estimated statistical cardinality count is decreased. The time component can also be referred to as a geometric discount factor over time.

In some examples, the constant is less than 1 and greater than 0. Consequently, the exponential time-based decay has a decaying effect.

In some examples, the decay circuitry is configured to inhibit application of the exponential time-based decay to a most recent estimation of the statistical cardinality count of a substream and apply it to the difference between the most recent estimation and a previous estimation, if the difference is positive. If a small cardinality is seen when a large cardinality was previously seen then the larger one is discounted because it was in the past. The current cardinality is accounted without a discount (decay) because it is estimated now. For instance, at time 4000000 we see zzz00000 so we estimate 2⁵=32 row activations and record the length 5. At time 4000100 we see zzzzzz00 so we estimate 2²=4 row activations now. We had 32 100 time units ago, so we discount the difference 32−4=28 by a discount factor 0.99 obtaining 28×(0.99¹⁰⁰)=10.248 so the new estimation is 10.248+4=14.248. If at time 4000100 we got instead xx000000, the estimate would have been 2⁶=64 and the difference to the previous estimate 2⁵=32 would have been −32 rather than +4, so it would have been negative. In that case, we would have updated only the length 6 because this corresponds top the cardinality seen now.

In some examples, the decay circuitry is configured to inhibit application of the exponential time-based decay during estimation of the statistical cardinality count when the statistical cardinality count drops. The decay is therefore limited to situations where the statistical cardinality appears to be decreasing since this is the situation where rowhammer attacks may be occurring. If the statistical cardinality appears to be increasing (more contiguous most-significant zeros are seen than before) then new addresses are being accessed and so a rowhammer attack is unlikely to be in progress.

In some examples, the decay circuitry is configured to apply the exponential time-based decay multiple times to the statistical cardinality count. In this way, even though certain data is stored for the statistical cardinality count, the process can be thought of as ‘memoryless’ as to whether the decay has been applied before or not. Indeed, if the number of contiguous most-significant zeros of the addresses decreases from A to E, the present technique is unaffected by whether this occurs via intermediate values B, C, D or whether the number of contiguous most-significant zeros goes straight from A to E.

In some examples, the memory system is configured to use a plurality of trench capacitors, each to store a single bit. Such memory systems can be susceptible to rowhammer attacks due to the leakage of electrons between one (hammered) trench capacitor that stores one bit and a neighbouring trench capacitor that stores another bit. If sufficient leakage occurs, the electrons in the trench capacitor rise to a level where, during the refresh process, the trench capacitor is ‘refreshed’ with the wrong value.

Particular embodiments will now be described with reference to the figures.

FIG. 1 illustrates an example of a memory system 160 that is implemented using a number of trench capacitors 300, 310, 320, 330, 340 (etc). Each trench capacitor is responsible for storing a single bit by storing (or not storing) electrons. Over time, electrons leak from the trench capacitors 300, 310, 320, 330, 340. A ‘refresh’ is therefore performed every period. In this, a determination is made as to whether the charge on the capacitor is above or below a particular threshold, and this is used to either drain the capacitor back to ground (e.g. to indicate the storage of a ‘0’) or restore the charge on the capacitor to ‘full capacity’ (e.g. to indicate the storage of a ‘1’). Such a system 160 is susceptible to a so-called ‘rowhammer’ attack. In this, the circuitry related to the access to a particular cell/capacitor 310 is repeatedly activated over a short period in an effort to cause electrons to leak from that capacitor 310 into neighbouring capacitors 300, 320. If enough leakage occurs, the overall charge stored on a neighbouring capacitor exceeds the threshold and at the next refresh period, the capacitor will be charged, thereby storing a different value (e.g. a ‘1’ rather than a ‘0’). If the capacitor 320, 300 that has its value changed is storing sensitive data such as a permission then this can result in a privilege escalation or access to otherwise sensitive data. A row 350 of the trench capacitors may correspond to a memory address with, for instance, 8 trench capacitors within that row forming the byte to which the memory address points.

FIG. 2 schematically illustrates a data processing apparatus 100. The data processing apparatus 100 includes a load/store unit 110, which is an example of the claimed memory access circuitry (another example could be a last level cache in a cache hierarchy that sends requests out to a main memory, e.g. backed by DRAM). This is responsible for receiving operations corresponding to instructions to access memory, and asserting the relevant signals to cause a memory access request to be issued to a memory system 160. Estimation circuitry 120 is provided in order to provide an estimated statistical cardinality count. Decay circuitry 130 is provided to selectively decay this estimate using an exponential time-based decay parameter. Restriction circuitry 140 can then be used to restrict the memory access requests being transmitted to the memory system 160 based on this decayed statistical cardinality counts. In this example, the estimation circuitry 120 includes separation circuitry 150. This is so that the memory access requests can be ‘randomly’ divided into a number of streams, with an estimated statistical cardinality count being calculated (and decayed) for each stream. An overall aggregation operation (e.g. a harmonic mean) is performed over each of these values to provide an overall estimate of the statistical cardinality count of the aggregating stream. By calculating the cardinality count of the aggregated stream, it is possible to more accurately spot memory access patterns that correspond to rowhammer attacks-namely a small number of locations in the memory system being accessed frequently within a small period as compared to other locations of the memory system.

FIG. 3 illustrates an example of the estimation circuitry 120 and decay circuitry 130. The hash circuitry 210 forms part of the separation circuitry. In particular, it takes the row address of a memory access request (which could typically be to a row of trench capacitors in a physical memory system) and performs a hash on that address. The purpose of the hash is to ‘randomise’ the addresses so that the same input address will give the same hashed (output) address so that repeated accesses to the same address can be detected, but that otherwise, the relationship between input addresses and hashed (output) addresses is effectively random. The hash function performed by the hash unit 210 could therefore be a cryptographic hash. In some embodiments, the hash function has the avalanche property (also known as the butterfly property) in which a small change in the input address produces a large change in the hashed (output) address thereby providing a better distribution of hashed (output) addresses. In this case, the hash algorithm produces a 64-bit output, which is separated into a first group of 52 bits (x) and a second group of 12 bits.

The 52 bits are passed to the find-first-set circuitry 230, which is an example of part of the estimation circuitry 120 that determines the number of contiguous most-significant zeros in the row memory address (specifically these 52 bits of the hashed memory address). The find-first-set operation is achieved by an operation mathematically equivalent to max (log₂(x[0:51] & −x[0:51])+1, 0), which determines the position of the first bit equal to 1 in x and returns the length of the suffix as logarithm in base 2 of that position (note that the use of x[0:51] means that the bits of x are reversed during the operation). The resulting number (b) is output to discounted update circuitry 240, which performs the decay function. Note that a different pattern can also be detected, which might therefore not necessitate the reversal of the 52 bits. For instance, if a pattern of most-significant zeros is detected, then the bits need not be reversed.

The other 12 bits are used as an indication of the stream to which this access belongs. The 12 bits are used as a read address for memory 220, which is an example of the claimed storage circuitry. The memory 220 stores estimated statistical cardinality counts in form of observed length and timestamps for each stream and so in this example, stores 4096 different (estimated statistical cardinality count, timestamp) pairs. The read address is used to access the relevant entry in the memory 220 and provide the stored values that are stored for the stream (a). The result is then passed to the discounted update circuitry 240.

At the discounted update circuitry 240, an exponential time-based discount/decay is applied. In particular, if the estimated statistical cardinality count has increased (if the previously recorded value in a is less than b) then no adjustment takes place. Otherwise, the updated value is equal to the new value plus a difference between the old and new values that is weighted so as to reduce its significance. The weighting is exponential and is based on the time since the previous value was recorded. Thus, higher estimated statistical cardinality counts that were seen long ago are given little weight and the new estimated statistical cardinality count will be closer to the recently calculated value. Previous high values are not dismissed entirely (unless a very long time passes). Note also that since no adjustment is made when the estimated statistical cardinality count is increased if a truly random stream of addresses is passed in (which will be the case unless the same address is being repeatedly accessed), then one would expect the estimated statistical cardinality count to generally remain high even if occasional small decreases occur.

There are a number of ways that a weighting can occur. However, in these examples, the equation used to calculate the decay is as follows:

$$b + ( a - b ) {m}^{t}$$

Where b is the determined number of contiguous leading zeros calculated based on the current access address, a is the previously stored estimated statistical cardinality count, m is a constant (e.g. 0.9999) and t is the time between this access and the most recent previous access in this stream (e.g. in nanoseconds).

Having determined the new value, this new value is then stored to the memory 220 for this particular stream, together with the current timestamp.

To determine the overall estimated statistical cardinality count (i.e. across the memory system 160), a centre-biasing function is performed by performing a harmonic mean of the individual statistical cardinality count values in the memory. It will be appreciated that other techniques of centre biasing (such as those proposed in “HyperLogLog in Practice: Algorithmic Engineering of a State of The Art Cardinality Estimation Algorithm” by Stefan Heule et al can also be used)

The result of this operation can then be considered to determine whether evasion action should be taken (e.g. by the restriction circuitry). There are a number of ways to do this. One way is to look for a sudden drop of a certain amount while the total throughput of accesses to the memory is high and that if such a drop occurs, it can be concluded that a rowhammer attack might be occurring. In another situation, one could look to see whether the estimated statistical cardinality count fell below a predetermined value while the total throughput of accesses to the memory is high and if so, to assume that a rowhammer attack might be occurring. Another option might be to compare the ratio of the previous and new values of the estimated statistical cardinality count. In each case, a drop in the estimated statistical cardinality count signifies that a smaller range of memory addresses is being accessed and therefore a rowhammer attack might be occurring.

Note that it is not particularly relevant which bits are used to determine the substream number after the hash has been performed, provided this remains consistent, so this can be varied across measurements to prevent an attacker from devising an adversarial pattern which defies a specific hash function and leads to a wrong cardinality estimation.

FIG. 4 illustrates a flowchart 400 that shows a method of data processing. At a step 405, an access request is received. At a step 410, the stream to which the access is associated is identified by hashing the access address and using some of those bits to identify a stream number. The number of streams into which the access requests is split is determined (as explained above) based on the susceptibility of the memory system to rowhammer attacks. At a step 415, the number of “leading zeros” (contiguous most-significant zeros) in at least part of the hashed address (e.g. those not used for the stream identifier) is counted as b. At a step 420, the previously stored data for the stream (a) is obtained (e.g. from the memory 220). At a step 425, a comparison is made between a and b. If b is greater than or equal to a then at step 430, the value stored in the memory 220 for the stream is simply equal to b. Otherwise, at step 435, the value stored for the stream in the memory is equal to b+(a−B)m^{t} where m is the constant 0.9999 and t is the number of nanoseconds between the time of the current access and the previous access stored as part of a. The value of m can of course differ, but is kept between 0 and 1 so as to provide a decay effect. The process continues (with further access requests being handled) at step 440.

On a regular schedule, at step 443, the harmonic mean of all the estimated statistical cardinality counts is calculated. At step 445, it is determined whether the harmonic mean has dropped. If so, then at step 450, the access rate of the memory accesses is decreased so that rowhammer attacks are essentially inhibited. This restriction could be to the addresses currently being accessed or could be across the whole of the memory system 160. Otherwise, the current access remains the same in step 455.

Note that in this example, the harmonic mean is calculated (at step 440) in response to every access request. In other embodiments, the harmonic mean is only calculated periodically-either after a certain number of accesses have been made, every period, or possibly even after a significant decrease of the estimated statistical cardinality count for a single stream.

FIG. 5 illustrates source code (written in python) of an algorithm that implements the process illustrated by the flowchart 400 of FIG. 4. The class DiscountedHyperLogLog implements three methods. A first initialisation method (_init_) sets the discount constant (referred to as ‘m’, above) to 0.9999 as previously discussed, and also initialises the memory so that each initial statistical cardinality count value is 0 (for each stream). The size of the array M is equal to the number of substreams. An internal counter (C), that is used to count time is also initialised to 0. In this way, time is measured as the memory access number.

A second method (add) is used to add (or update) the estimated statistical cardinality count for a particular address (value). The value is first hashed (using SHA1 in this case). The variable ‘j’ is used to identify the substream associated with the access (value). The variable ‘w’ is used to store the part of the hashed value that is used to determine the estimated statistical cardinality count, with self.p indicating the split between the bits used to determine the stream identifier and the bits used to perform the estimated statistical cardinality count. The variable ‘b’ again represents the length of the unique pattern (typically and in this case all leading zeros) calculated for the hashed access. The variable C is then updated (as occurs at each call of ‘add’) to account for elapsed time and differently than from this example, this update could consist also of multiple time units. The value of b is then compared to the currently stored value for the stream. If b is larger then the stored value is simply updated with the new larger value. Otherwise, the value has the decay parameter applied as previously discussed. Note that the value of M [j] that is stored is actually the log base 2 of the estimated cardinality count. The value T indicates the time at which a stream was previously accessed. At the end of this, the access time for the current stream is updated with the current access time (C).

A third method (card) is used prior to determining the harmonic mean (via super( ).card( )). It iterates through the entries that are stored in the memory (M) and reapplies the decay directly to the stored value for each stream. This is necessary because one substream might have been last updated a considerable time before card( ) is called, so it needs to be discounted by the elapsed time. One can view this as a virtual access with unique prefix length zero.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A data processing apparatus comprising: memory access circuitry configured to issue access requests to a memory system; estimation circuitry configured to estimate a statistical cardinality count on memory row addresses accessed by the access requests;
and decay circuitry configured to apply an exponential time-based decay during estimation of the statistical cardinality count.

2. The data processing apparatus according to claim 1, comprising: restriction circuitry configured to restrict the access requests in response to the statistical cardinality count.

3. The data processing apparatus according to claim 1, wherein the restriction circuitry is configured to restrict the rate at which the access requests are issued to the memory system to at least some of the memory row addresses in response to the statistical cardinality count.

4. The data processing apparatus according to claim 2, wherein the restriction circuitry is configured to restrict the access requests in response to the statistical cardinality count dropping.

5. The data processing apparatus according to claim 1, wherein the estimation circuitry is configured to estimate the statistical cardinality count on the memory row addresses using a longest seen pattern in the memory row addresses.

6. The data processing apparatus according to claim 1, wherein separation circuitry to separate accesses requests into a plurality of sub streams and to estimate the statistical cardinality count on the memory row addresses by estimating a statistical cardinality count for each of the substreams.

7. The data processing apparatus according to claim 6, wherein the statistical cardinality count on the memory row addresses is calculated by performing a centre-biasing function on the statistical cardinality count for each of the substreams.

8. The data processing apparatus according to claim 6, comprising: hash circuitry to hash each of the memory row addresses prior to being provided to the estimation circuitry.

9. The data processing apparatus according to claim 8, wherein the access requests are separated into the plurality of substreams based on predetermined bits of the memory row addresses after being hashed.

10. The data processing apparatus according to claim 8, wherein the hashes are cryptographic hashes.

11. The data processing apparatus according to claim 5, wherein the estimation circuitry is configured to estimate, for each substream in the substreams, the statistical cardinality count of that substream by using a longest seen pattern in the memory row addresses of that substream.

12. The data processing apparatus according to claim 5, wherein the estimation circuitry comprises storage circuitry to store, in association with each substream of the substreams, a time at which a next-most recent one of the access requests associated with that substream was seen; and the decay circuitry is configured to adjust the statistical cardinality count for each substream of the substreams based on the time between successive ones of the access requests belonging to that substream.

13. The data processing apparatus according to claim 12, wherein the exponential time-based decay is equal to a constant raised to the power of a time component; and
the time component is based on the time between successive ones of the access requests belonging to that substream.

14. The data processing apparatus according to claim 13, wherein the constant is less than 1 and greater than 0.

15. The data processing apparatus according to claim 6, wherein the decay circuitry is configured to inhibit application of the exponential time-based decay to a most recent estimation of the statistical cardinality count of a substream and apply it to the difference between the most recent estimation and a previous estimation, if the difference is positive.

16. The data processing apparatus according to claim 1, wherein the decay circuitry is configured to inhibit application of the exponential time-based decay during estimation of the statistical cardinality count when the statistical cardinality count drops.

17. The data processing apparatus according to claim 1, wherein the decay circuitry is configured to apply the exponential time-based decay multiple times to the statistical cardinality count.

18. The data processing apparatus according to claim 1, wherein the memory system is configured to use a plurality of trench capacitors, each to store a single bit.

19. A data processing method comprising: issuing access requests to a memory system; estimating a statistical cardinality count on memory row addresses accessed by the access requests; applying an exponential time-based decay during estimation of the statistical cardinality count.

20. A computer-readable medium to store computer-readable code for fabrication of a data processing apparatus comprising: memory access circuitry configured to issue access requests to a memory system; estimation circuitry configured to estimate a statistical cardinality count on memory row addresses accessed by the access requests; and decay circuitry configured to apply an exponential time-based decay during estimation of the statistical cardinality count.
